(19) United States
(12) Patent Application Publication
(10) Pub. No.: US 2003/0028644 A1
(43) Pub. Date: Feb. 6, 2003

(54) System and method for load sharing within a core network

(76) Inventors: Patrick Maguire, Ballinamore (IE); Peter Hans Edlund, Tumba (SE)

Correspondence Address: JENKENS & GILCHRIST, P.C., Suite 3200, 1445 Ross Avenue, Dallas, TX, 75202-2799, US

(21) Appl. No.: 10/127,055

(22) Filed: Apr. 18, 2002

Related U.S. Application Data
(60) Provisional application No. 60/309,982, filed on Aug. 2, 2001.

(51) Int. Cl. G06F 15/173

(52) U.S. Cl. 709/226

(57) ABSTRACT

A method and system for load sharing among a plurality of pooled network resources disclosed wherein each network resource includes a load reporting logic for storing load data from the plurality of pooled network resources and for distributing load data from the respective network resource to the plurality of pooled network resources.

### RELATED APPLICATION(S)

This application claims priority from and incorporates herein by reference the entire disclosure of U.S. Provisional Application Serial No. 60/309,982 filed Aug. 2, 2001.

### TECHNICAL FIELD

The present invention relates to load sharing within a core network, and more particularly, to a system and method for providing a load reporting function within pooled network resources of a core network.

### BACKGROUND OF THE INVENTION

The requirement to have a radio network controller (RNC) or base station controller (BSC) controlled by a single mobile switching center (MSC) server or Serving GPRS Support Node (SGSN) (network resources) leads to certain limitations. Allowing BSCs and RNCs to connect to a number of MSC servers or SGSNs increases the networks performance in terms of scalability, by distributing the network load amongst the serving entities, and reducing the required signaling as a user roams. Current standardization work within 3GPP proposes a solution wherein one or more RNCs or BSCs can be connected to one or more MSCs or SGSNs. However, to date there has been no solution for providing load sharing amongst the pooled network resources.

The purpose of connecting RNC/BSC nodes to multiple MSC/SGSN nodes is to increase serviceability, reduce signaling traffic in the core network, achieve load balancing within certain core network areas and support easier core network capacity expansion. Within a pool-area, a number of MSC/SGSN nodes are grouped together. Any MSC/SGSN node in such a pool area may provide service to a user entity (UE) in the pool area. The pool area concept provides a mobile station within the radio coverage of the pool area the potential to be handled by one MSC/SGSN for the whole pool area. Therefore, the core network nodes have to share responsibility for all location areas (LAs) and routing areas (RAs) of the pool-area. Thus, every network resource can handle mobile stations in all location areas and routing areas of the pool area. This leads to a significant reduction of signaling traffic within the core network since external location updates, SGSN relocation and inter-MSC hand-over procedures become obsolete to a large extent.

The mechanism for keeping a mobile station associated with one dedicated core network node is the provisioning of a network resource identifier (NRI). The NRI is provided to an RNC via the mobile station with each new mobile station core network signaling connection establishment. Connecting a Radio Access Network (RAN) to multiple core network nodes requires a Non Access Stratum (NAS) node selection function within the RNC nodes. This function is used to assign specific network resources to serve the mobile station and subsequently route the control plane traffic to the associated network resource. The routing function entity in the RNC analyses the access stratum part of the RRC-Initial-direct-transfer message from a mobile station. Based upon the information in the intra domain NAS node selector (IDNNS), and the core network domain indicator, the routing decision in the RNC is made. The information in the IDNNS is provided by the NAS entity to the mobile station.

The RNC routes initial NAS signaling messages according to the NRI and the “domain indicator” (CS(circuit switched) or PS(packet switched)) to the relevant core network node if a core network node address is configured in the RNC for the specified NRI and the requested domain. If no core network node address is configured in the RNC for the requested NRI and domain, the RNC routes the initial NAS signaling message to a core network node selected from the available core network nodes which serve the domain.

One of the objectives of the pooled area is to achieve load distribution among available network resources in the pool while simultaneously reducing signals as mobile stations roam about a pool area. However, the NAS node selection function in the RAN has no data on the current load within each network resource within the pool to which the NAS node selection function must assign a mobile station.

### SUMMARY OF THE INVENTION

The present invention overcomes the foregoing and other problems with a system and method for load sharing among the plurality of pooled network resources. Each of the plurality of pooled network resources include a load reporting function for storing load data received from the other members of the plurality of pooled network resources. The load reporting function also distributes load data from the network resource to the remaining plurality of pooled network resources. The load data is transmitted and received via an interface of the network resource.

### BRIEF DESCRIPTION OF THE DRAWINGS

A more complete understanding of the method and apparatus of the present invention may be obtained by reference to the following Detailed Description when taken in conjunction with the accompanying Drawings wherein:

FIG. 1 illustrates the structure of a core network with pool areas;

FIG. 2 illustrates implementation of the load reporting function within a MSC pool;

FIG. 3 illustrates implementation of the load reporting function within a SGSN pool;

FIG. 4 illustrates load information transmitted over network resource, interfaces;

FIG. 5 illustrates an interface between a load reporting function and a mobile management entity;

FIG. 6 is a flow diagram illustrating the distribution of load information;

FIG. 7 is a flow diagram illustrating an alternative method for distributing load information.

FIG. 8 illustrates an availability table for network resources; and

FIG. 9 is a flow diagram illustrating the assignment of a mobile station to a network resource.

### DETAILED DESCRIPTION

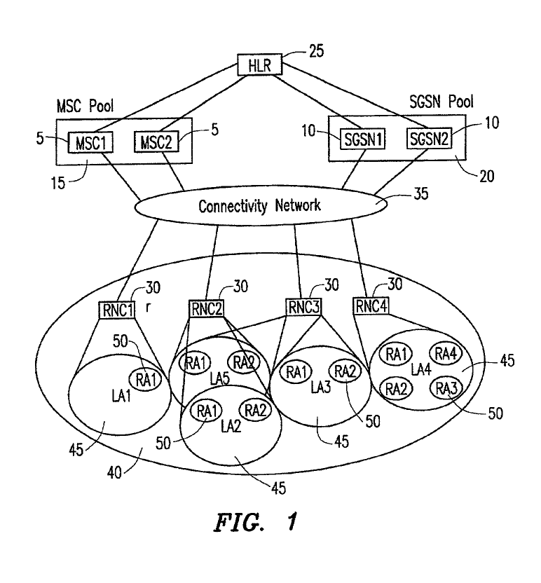

Referring now to the drawings, and more particularly to FIG. 1, there is illustrated the structure of a core network containing pool areas in which the system and method of the present invention are implemented. While the following description with respect to FIG. 1 is illustrative of one embodiment in which the system and method of the present invention may be implemented, it should be realized that various other implementations may be used in different or similar systems.

Network resources such as MSCs 5 and SGSNs 10 are grouped together within an MSC pool 15 and SGSN pool 20, respectively. These resources are able to obtain information about mobile stations assigned to these network resources by accessing a home location registration (HLR) 25 associated with a mobile station. The MSCs 5 and SGSNs 10 are able to access radio network controllers (RNCs) 30 via the connectivity network 35. The radio network controllers 30 assign mobile stations to any MSC 5 within the MSC pool 15 or to any SGSN 10 within the SGSN pool 20 through the connectivity network 35. By enabling the radio network controllers 30 to have access to any of the MSCs 5 and SGSNs 10 within their respective pools, the radio network controllers 30 are able to pool their resources such that a mobile station roaming in a pool area 40 can be served by a single MSC 5 or SGSN 10. The pool area 40 consists of a number of location areas 45 associated with each of the radio network controllers 30. Each location area 45 also include various routing areas 50 located therein. Within this system, each MSC 5 or SGSN 10 would be able to share responsibility for all location areas 45 and routing areas 50 of the entire pool area 40.

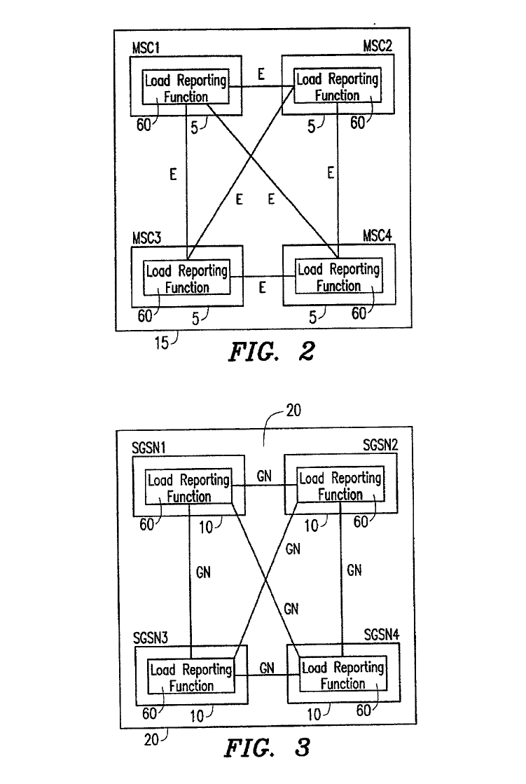

Referring now to FIGS. 2 and 3, there are illustrated implementations of a load reporting function 60 residing within each network resource, i.e., MSC 5 and SGSN 10, of the core network. The load reporting function 60 will store information relating to the current load supported by an associated network resource. The load reporting function 60 has the ability to report this information using existing MAP procedures to all other MSCs and SGSNs within the network resource pools. This information will be transmitted as additional backbone signaling over the E interface within the MSC pool 15 and over the GN interface within the SGSN pool 20. The initiation of distribution of the load information stored by the load reporting function 60 can either be trigger based, for example, the server load has decreased/increased by X % within T seconds, or may be periodically distributed. Either of these initiation functionalities may be configured by the user.

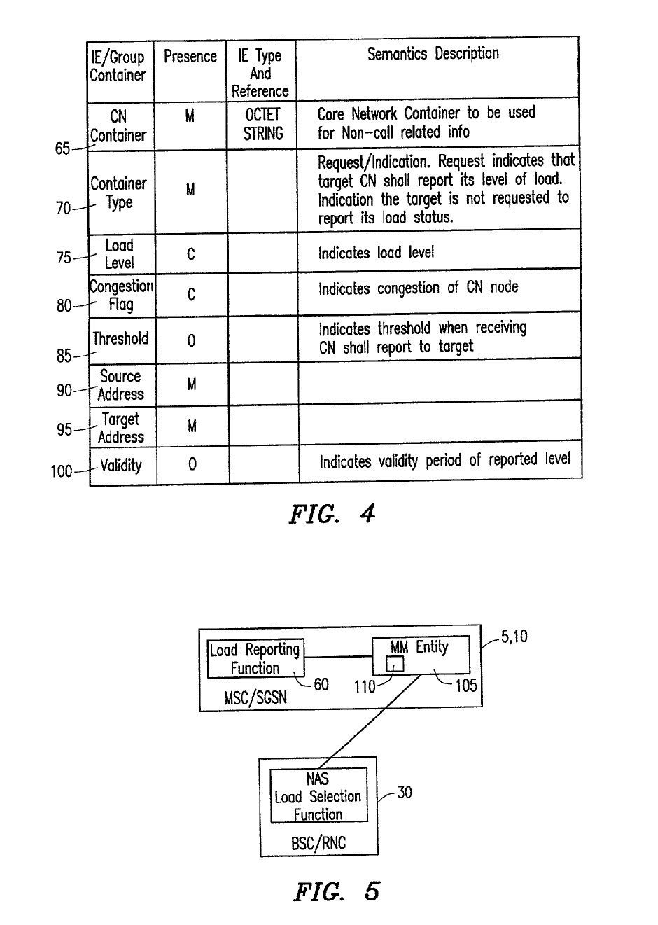

The load information for a particular network resource shall be passed over the E or GN interfaces respectively within a message as illustrated in FIG. 4, and includes the following information. The CN container 65 is a core network container used to store non-call related information. The container type 70 is a request/indication identifier. A request indicates that a target core network shall report its level of load. An indication indicates that the target core network is not requested to report its load status. The load level 75 indicates the load level of the associated MSC or SGSN. A congestion flag 80 provides an indication of the existence of congestion within a particular core network node. The threshold level 85 may be set to a predetermined level to indicate the threshold when a node shall report its load level. The source address 90 indicates the location from which the information is being transmitted and the target address 95 indicates the address to which the information is being sent. The validity indicator 100 indicates the validity period of the reported load level.

Referring now also to FIG. 5, the load reporting function 60 also interfaces with a mobility management entity (MME) 105 responsive to either a periodic timer or reaching of a selected load threshold. As mentioned previously, these factors are each configurable. Upon interfacing with the mobility management entity, the network resources will set a report NR load flag 110 within the mobility management entity 105. The report NR load flag causes each of the network resources (MSCs 5 and SGSNs 10) to download their load data as indicated in FIG. 4 to the various radio network controllers 30 within the core network.

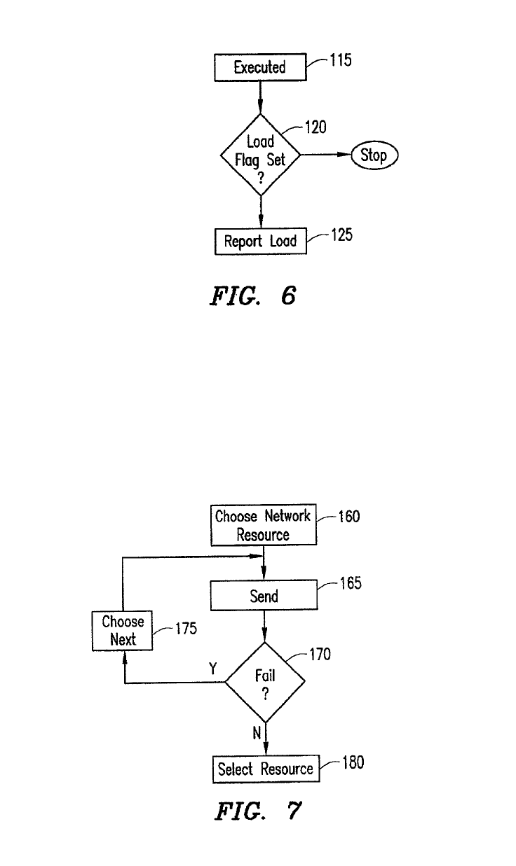

Referring now also to FIG. 6, each time a paging/RAU/LAU mobility management procedure is executed at step 115, the mobility management entity within the network resource determines if its report NR load flag 105 is set at step 120. If the report NR load flag 105 is set, the mobility management entity reports at step 125 the present server load of the currently accessed network resource if the process is load triggered or the present server load of one or more of the network resources in the pool if the process is triggered by a periodic timer. The information reported to the RNCs 30 may also contain load statistics for network resources from other pools in the case of overlapping pools. The information downloaded may also contain load statistics for network resources from other pools in the case of overlapping pools.

In an alternative embodiment, a new procedure could be implemented within the mobility management entity 105 wherein network resource load information is downloaded from all pooled network resources to associated RANs. This process requires a new signal to be broadcast from each network resource to all RNCs within a pool. The information downloaded may also contain load statistics for network resources from other pools in the case of overlapping pools.

In a further embodiment (FIG. 7), a new procedure may be implemented wherein a RNC 30 repeats location update request (LAR) to another network resource. For this solution, no backbone signaling between network resources 30 in a pool is required. An RNC chooses at step 160 a first network resource from a pool and sends at step 165 a LAR to the network resource 30. If the request fails due to the present load of the chosen network resource at inquiry step 170, the RNC is informed and subsequently it chooses another network resource to direct the location access request at step 175. Otherwise a network resource is selected at step 180.

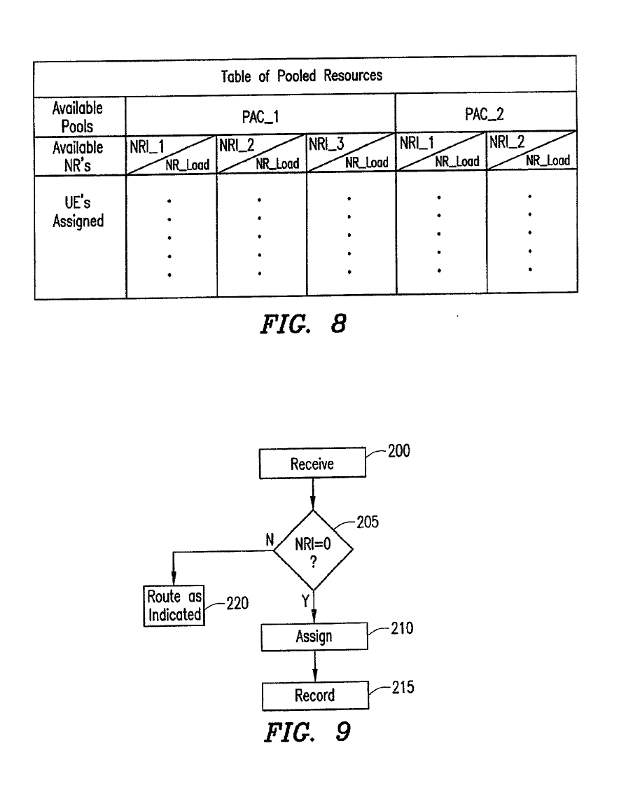

Referring now to FIG. 8, there is illustrated a table of pooled resources containing information on the availability of particular network resource. This information would be stored within a NAS node selection function. The network resource load is stored within the table and is expressed as a percentage of maximum load of the network resource. Additionally, the table of pooled resources contains information on the available pools, the network resources available within each pool and the network resource identifier associated with the network resource. Furthermore, a listing of the UEs assigned to a particular network resource is provided. Referring now to FIG. 9, using this information, the BSC/RNC 30 upon receipt of a RRC Initial Direct Transfer/MM related RR request from a mobile station at step 200, the RNC 30 analyses at step 205 the IDNNS of the mobile station. If the network resource indicator for the mobile station equals zero, the mobile station is assigned to the network resource with the smallest load from one of the provided pools at step 210. The assigned routing data is recorded at step 215 in the NAS node selection function. If the NRI does not equal zero, the information is routed at step 220 according to the existing data within the NAS node selection function. In this way, the NAS node selection function may optimize the pool performance by directing subsequent initial mobile station uplink accesses to the network resource reporting the smallest load. This load information is downloaded from the core network to the RAN in a table having the structure as indicated in FIG. 8. This solution is applicable to A, GB and IU interfaces to pooled network resources and has minimal impact upon signaling within the core network.

The previous description is of a preferred embodiment for implementing the invention, and the scope of the invention should not necessarily be limited by this description. The scope of the present invention is instead defined by the following claims.

What is claimed is:

1. A method for load sharing among network resources, comprising the steps of:
storing load data at each of a plurality of pooled network resources within a core network; and
distributing the load data from at least one network resource of the plurality of pooled network resources to other pooled network resources.

2. The method of claim 1, further including the step of downloading the load data from at least one of the plurality of pooled network resources to at least one radio network controller.

3. The method of claim 2, further including the step of assigning a mobile station to a network resource responsive to the load data in the radio network controller.

4. The method of claim 3, wherein the step of assigning further comprises the step of assigning the mobile station to a network resource having a smallest load as indicated by the load data.

5. The method of claim 2, wherein the step of downloading further comprises the steps of:
detecting execution of at least one of a paging procedure, an RAU procedure, or an LAU procedure;
determining whether a load flag is set at a mobility management entity responsive to a detection; and
downloading the load data if the load flag is set.

6. The method of claim 1, wherein the step of distributing is responsive to expiration of a selected time period.

7. The method of claim 1, wherein the step of distributing is responsive to attaining a selected load level at the at least one network resource.

8. A network resource, comprising:
a load reporting function for storing load data from a plurality of pooled network resources, said load reporting function further distributing load data from the network resource to the plurality of pooled network resources; and
an interface for outputting the load data of the network resource and receiving the load data from the plurality of pooled network resources.

9. The network resource of claim 8, wherein the load reporting function further downloads the load data from the network resources to at least one radio network controller.

10. The network resource of claim 9, wherein the load reporting function further:
detects execution of at least one of a paging procedure, an RAU procedure, or an LAU procedure;
determines whether a load flag is set at a mobility management entity responsive to a detection; and
downloads the load data if the load flag is set.

11. The network resource of claim 8, wherein the load reporting function distributes the load data responsive to expiration of a selected time period.

12. The network resource of claim 8, wherein the load reporting function distributes the load data responsive to attaining a selected load level at the network resource.

13. A network comprising;
a plurality of pooled network resources configured to store load data for the plurality of pooled network resources and distribute the load data amongst the plurality of pooled network resources; and
a plurality radio network controllers connected to any of the plurality of pooled network resources, said plurality of radio network controllers controlling coverage of a pooled radio coverage area.

14. The network of claim 13, wherein the plurality of network resources are further configures to download the load data from at least one of the plurality of pooled network resources to at least one radio network controller.

15. The network of claim 14, wherein the plurality of radio network controllers are further configured to assign mobile station to a network resource responsive to the load data in the radio network controller.

16. The network of claim 17, wherein plurality of radio network controllers are further configured to assign the mobile station to a network resource having a smallest load as indicated by the load data.

17. The network of claim 14, wherein the plurality of network resources are further configured to:
detect execution of at least one of a paging procedure, an RAU procedure, or an LAU procedure;
determine whether a load flag is set at a mobility management entity responsive to a detection; and
download the load data if the load flag is set.

18. The network of claim 13, wherein the plurality of network controllers distributes the load data responsive to expiration of a selected time period.

19. The network of claim 13, wherein the plurality of network controllers distributes the load data responsive to attaining a selected load at the at least one network resource.

20. The network of claim 13, wherein the plurality of pooled network resources comprise mobile switching centers.

21. The network of claim 13, wherein the plurality of pooled network resources comprise Serving GPRS Support Nodes.
